(19) United States
(12) Patent Application Publication
(10) Pub. No.: US 2024/0269698 A1
(43) Pub. Date: Aug. 15, 2024

(54) DISPENSER CAP GUARD

(71) Applicant: TricorBraun Inc., St. Louis, MO (US)

(72) Inventors: Michael D. Murphy, Evergreen Park, IL (US); Craig Sawicki, Roselle, IL (US)

(21) Appl. No.: 18/437,787

(22) Filed: Feb. 9, 2024

Related U.S. Application Data
(60) Provisional application No. 63/484,110, filed on Feb. 9, 2023.

(51) Int. Cl. B05B 11/10

(52) U.S. Cl. CPC B05B 11/1049

(57) ABSTRACT

A cap guard includes an annular collar having a collar sidewall, a connecting rim extending from an upper portion of the collar sidewall, and an open top; the collar sidewall having a collar internal snap bead extending around the collar sidewall interior and the connecting rim having an external snap bead extending partially around the connecting rim exterior, the connecting rim external snap bead having at least one break and the break having a distance D; an annular over cap having an over cap sidewall and a closed top surface; an alignment snap bead around the over cap sidewall internal surface, the alignment snap bead having a length L¹ equal to or less than the distance D; one or more securing snap beads around the over cap sidewall internal surface separate from the alignment snap bead, each securing snap bead having a length L² greater than the distance D.

### CROSS REFERENCE

This application claims priority to U.S. Provisional Application No. 63/484,110 filed on Feb. 9, 2023, the entire disclosure of which is hereby incorporated by reference herein.

### TECHNICAL FIELD OF THE INVENTION

This invention generally relates to product packaging and, more particularly, to a guard for caps of dispensing containers, for example, foaming, spray, or liquid dispensers to limit access to the container contents and operation of the pump or spray mechanism.

### BACKGROUND

Traditional dispensing bottles are generally composed of two sections: a bottle and a mechanical pump or spray mechanism (collectively referred to herein as a pump mechanism or pump mechanisms). The bottle stores the product while the mechanical pump mechanism expels the product from the bottle. The mechanical pump mechanism may dispense the contents as a liquid, fine spray or mist, or a foam and typically includes a tube that extends down into the bottle, a pump or trigger, an outlet, and a collar that secures the pump mechanism to the bottle. One common attachment method is to provide mating screw threads on the inside of the collar and on the outside surface of the top end of the bottle, thereby allowing the user to screw the collar, and with it the entire pump mechanism, on and off the bottle.

Dispensing bottles of this common design are employed to hold and dispense an immense variety of primarily liquid products, including anything from water to household cleaners. Dispensing bottles may be used by product manufacturers for product packaging or sold as a separate item, in which case the purchaser may fill the bottle with a substance of their choosing.

In the case of dispensing bottles being used as product packaging, it is possible that a manufacturer may fill bottles with a product that presents some possibility of harm if it is ingested. The danger of accidental ingestion of the contents may come from either removal of the entire pump mechanism or operation of the pump mechanism, particularly when a child has access to the product.

Another issue with such dispensing bottles or containers is inadvertent actuation of the pump mechanism resulting in mess and wasted product.

Therefore, it would be desirable to have a security device capable limit access to the contents of the dispensing container by removal of the pump mechanism and prevent unintentional actuation of the pump mechanism. Furthermore, a security device requiring coordinated two hand action by the user to remove the device and use the pump mechanism-while still restricting separation of the pump mechanism from the bottle would also be desirable. However, no such suitable device, that is not permanent, has been available to date. The present disclosure is directed to overcoming one or more of the problems set forth above.

### SUMMARY

An aspect of the present disclosure is to provide cap guard for a dispensing container that includes an annular collar having a collar sidewall, a connecting rim extending from an upper portion of the collar sidewall, and an open top; the collar sidewall having a collar internal snap bead extending around a portion of an interior of the collar sidewall adjacent a lower edge of the collar sidewall and the connecting rim having an external snap bead extending partially around an exterior surface of the connecting rim, the snap bead having at least one break therein and the break having a distance D; an annular over cap having an over cap sidewall and a closed top surface; an alignment snap bead extending around a first portion of an internal surface of the over cap sidewall, the alignment snap bead having a length L¹ equal to or less than the distance D of the break; and one or more securing snap beads extending around a second portion of the internal surface of the over cap sidewall separate from the alignment snap bead, each securing snap bead having a length L² greater than the distance D of the break.

Another aspect of the present disclosure is to provide a cap guard as described above and also including a collar positioning indicator on an external surface of the collar sidewall, wherein the collar positioning indicator is aligned with the break; and an over cap positioning indicator on an external surface of the over cap sidewall, wherein the over cap positioning indicator is aligned with the alignment snap bead.

Another aspect of the present disclosure is to provide method of restricting removal of the pump mechanism and actuation of the pump mechanism requiring coordinated action of both hands of a user to access the pump mechanism.

These aspects are merely an illustrative aspect of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an exploded perspective view of a bottle and cap guard according to an embodiment of the present disclosure.

FIG. 2 is a perspective view of a collar for the cap guard of FIG. 1.

FIG. 3 is a cross-section of the collar of FIG. 2.

FIG. 4 is a top perspective view of an over cap for the cap guard of FIG. 1.

FIG. 5 is a bottom perspective view of the over cap of FIG. 4.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

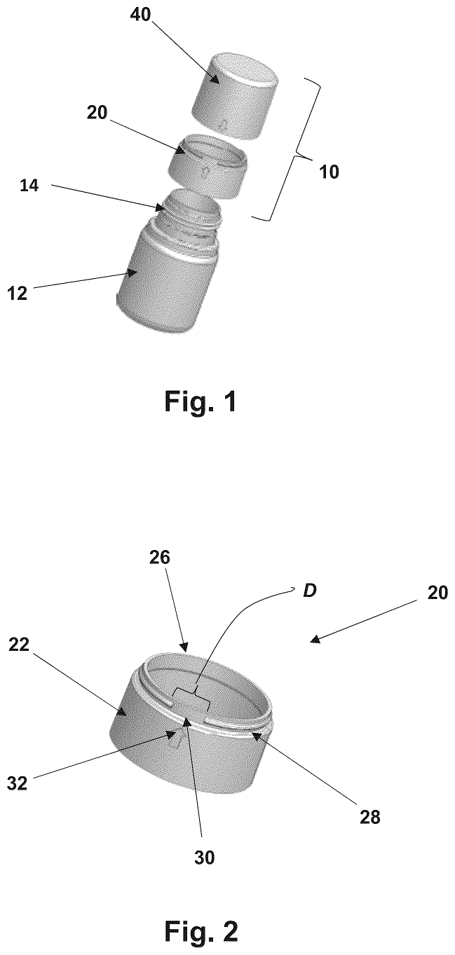

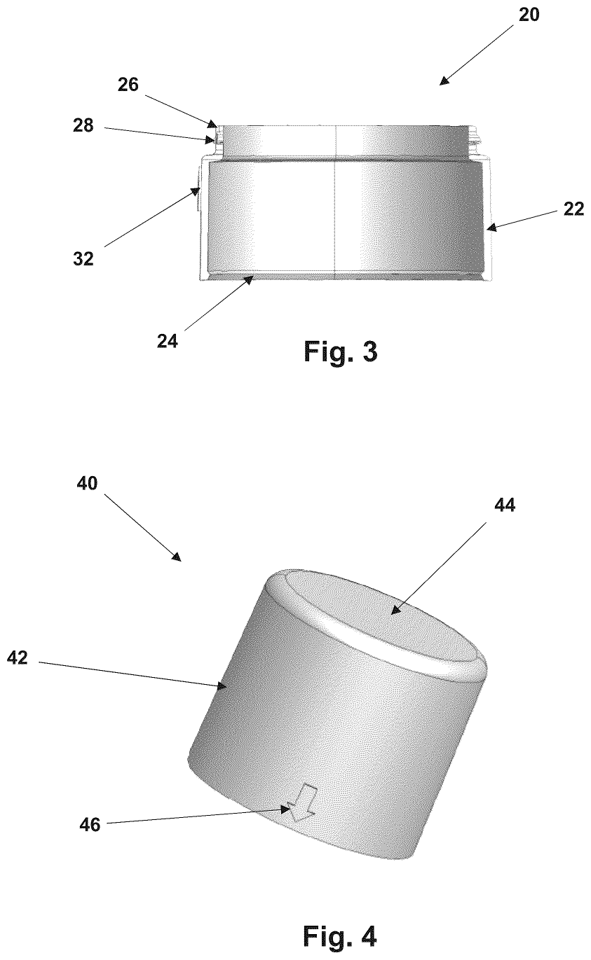

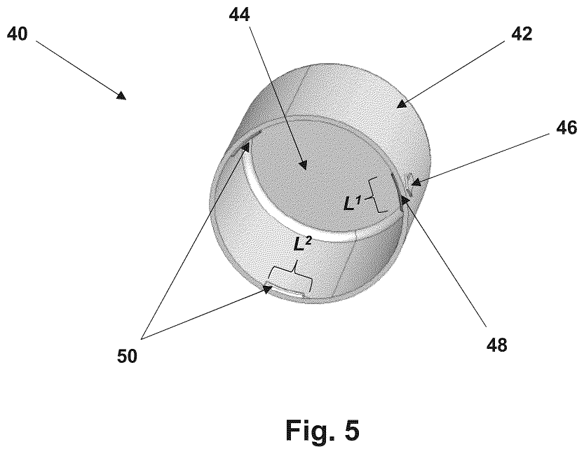

FIGS. 1-5 illustrate an embodiment of a cap guard 10 as used with a bottle 12 according to an embodiment of the present disclosure. The cap guard 10 includes a collar 20 and an over cap 40 that coordinate with one another to restricting removal of a pump mechanism (not shown) connected to the bottle 12 and actuation of the pump mechanism and requiring coordinated two hand action by a user to access the pump mechanism.

The collar 20 includes an annular main sidewall 22 having an inner diameter sufficiently large to allow the collar 20 to slide over the neck and threads of the neck of the bottle 12 and rotate freely around the neck 14 of the bottle 12. An internal snap bead 24 is provided at a lower edge of the annular main sidewall 22 and is configured to engage a lower portion of a collar of the pump mechanism or a corresponding external snap bead located around the neck 14 of the bottle 12 to secure the collar 20 onto the bottle neck 14 while retaining free rotation of the collar 20. The collar sidewall 22 may be provided with a height slightly greater than a distance from the bottle neck 14 snap bead to the top surface of a portion of the pump mechanism that screws onto the bottle neck 14 such that the annular collar 20 completely covers that portion of the pump mechanism when the annular collar 20 is snapped into place to prevent user access to that portion of the pump mechanism. In that manner, the annular collar 20 prevents the pump mechanism from being removed from the neck 14 of the bottle 12.

An annular connecting rim 26 extends upwardly from the upper portion of the collar main sidewall 22. The connecting rim 26 may be inset from the collar main sidewall 22 such that the connecting rim 26 has a smaller inner diameter and outer diameter than that of the color main sidewall 22 creating an internal, inward step where the collar main sidewall 22 transitions to the connecting rim 26. Advantageously, this step provides a means to engage the top edge of a portion of the pump mechanism that screws onto the bottle neck 14. As a result, the collar 20 may both prevent access to the portion of the pump mechanism so that it cannot be turned and prevent the pump mechanism from being lifted away from the bottle neck 14.

An external snap bead 28 extends partially around the outer circumference of the connecting rim 26. The external snap bead 28 is preferably provided with a break 30 of a distance D. In the illustrated embodiment, the external snap bead 28 extends continuously around the circumference of the connecting rim 26 other than at the break 30. A collar positioning indicator 32-an upwardly pointing arrow in the illustrated embodiment-is aligned with the break 30 in the external snap bead 28.

The collar 20 is open at its top end to allow the pump mechanism to pass through the collar 20 and extend above it.

The over cap 40 includes an annular sidewall 42 and enclosed top end 44. The over cap sidewall 42 has an inner diameter that allows the over cap sidewall 42 to fit over the connecting rim 26. The over cap sidewall 42 may have an outer diameter roughly equal to an outer diameter of the collar main sidewall 22, which allows the over cap sidewall 42 and collar main sidewall 22 to have a consistent outer surface appearance when the two pieces are connected. However, this is not essential to the operation of the cap guard 10.

The inner surface of the over cap sidewall 42 is provided with multiple snap beads 48, 50 along its lower edge. The snap beads 48, 50 are configured to engage the collar external snap bead 28 as the over cap 40 is slipped over the connecting rim 26 to secure the over cap 40 onto the collar 20 while allowing the over cap 40 and collar 20 to freely rotate relative to one another while connected.

One of the snap beads on the over cap 40 is an alignment snap bead 48. The alignment snap bead 48 is provided with a length L¹ that is slightly less than the distance D of the break 30 in the collar external snap bead 28. This allows the alignment snap bead 48 to pass through the break 30 when the alignment snap bead 48 is aligned with the break 30. The over cap 40 may be provided with a positioning indicator 46-an arrow in the illustrated embodiment-to assist a user with positioning the over cap 40 and collar 20 in coordination with collar positioning indicator 32 to align the alignment snap bead 48 with the break 30.

In contrast to the alignment snap bead 48, securing snap beads 50 of the over cap 40 have a length L² that is greater than the distance D of the break 30. This arrangement prevents the securing snap beads 50 from being able to pass through the break 30 even when they are aligned with the break 30. The securing snap bead(s) 50 may be a series of separate beads or a single longer bead.

The foregoing configuration of the collar 20 and over cap 40 results in the requirement of coordinated use of both hands of a user in order to separate the over cap 40 from the collar 20 gain access to the pump mechanism. Because the collar 20 is able to rotate freely around the bottle neck 14, the user must hold the collar 20 in place with a one hand. Similarly, because the over cap 40 is freely rotatable relative to the collar 20, the user must use the other hand to rotate the over cap 40 to align the position indicators 32, 46 with one another and, as a result, the alignment snap bead 48 and the break 30. When the alignment snap bead 48 and break 30 are aligned, the user is able to lift that side of the over cap 40 away from the collar 20 inducing a tilt to the over cap 40. This allows sufficient play between the over cap 40 and collar 20 to allow the securing bead(s) 50 to pass over the collar external snap bead 28 with relatively minimal, if any, force from the user for complete removal of the over cap 40 while leaving the collar 20 in place around the bottle neck 14. As a result, the user is then able to access and manipulate the pump mechanism while still being unable to remove the pump mechanism from the bottle. The requirement of coordinated use of both hands of the user provides an enhanced level of security not present in other security devices.

To replace the over cap, the user simply slips the over cap 40 back over the connecting rim 26 and exerts a sufficient force to push the snap beads 48, 50 of the over cap 40 back over and past the collar external snap bead 28. This may be done with the collar 20 and over cap 40 in any rotational position relative to one another.

Embodiments of the cap guard 10 may be utilized with a range of pump mechanisms and dispensers, for example, foaming pumps, misting sprayers, liquid pumps, and others not expressly identified herein.

In one embodiment, a bottle 12 incorporating a pump mechanism and an embodiment of the cap guard 10 as described above may be assemble with the following steps. Advantageously, removal of the cap guard 10 for actuation of the pump mechanism requires coordinated action of both hands of a user. The annular collar 20 is positioned over and moved downwardly over the pump mechanism and bottle neck 14 such that an upper portion of the pump mechanism extends through the open end of the annular collar 20. Downward movement of the annular collar 20 relative to the pump mechanism and bottle neck 14 continues until the collar internal snap bead 24 contacts the neck external snap bead. Upon exertion of a sufficient force to slightly deform the annular collar 20, the collar internal snap bead 24 may move over and past the neck external snap bead to secure the annular collar 20 to the neck 14 of the bottle 12 in a freely rotatable manner. The over cap 40 may be positioned over and move downwardly over the connecting rim 26 of the annular collar 20 while aligning the alignment snap bead 48 with the break 30 until the one or more securing snap beads 50 contacts the connecting rim external snap bead 28. Upon exertion of a sufficient force to slightly deform the connecting rim 26 and/or the sidewall of the over cap 40, one or more securing snap beads 50 may move over and past the connecting rim external snap bead 28 secure the over cap 40 to the annular collar 20 in a freely rotatable manner.

The above steps may be performed in either order. In other words, the over cap 40 may be secured to the annular collar 20 either before or after the annular collar 20 is secured to the neck 14 of the bottle 12.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment but should be defined only in accordance with the following claims appended hereto and their equivalents.

What is claimed is:

1. A cap guard for a bottle having a pump mechanism, including:
an annular collar comprising:
a collar sidewall;
a connecting rim extending from an upper portion of the collar sidewall;
an open top;
wherein the collar sidewall further comprises a collar internal snap bead extending around a portion of an interior of the collar sidewall adjacent a lower edge of the collar sidewall; and
wherein the connecting rim further comprises an external snap bead extending partially around an exterior surface of the connecting rim, the connecting rim external snap bead comprising at least one break therein and the break having a distance D; and
an annular over cap comprising:
an over cap sidewall and a closed top surface;
an alignment snap bead extending around a first portion of an internal surface of the over cap sidewall, the alignment snap bead having a length L¹ equal to or less than the distance D of the break; and
one or more securing snap beads extending around a second portion of the internal surface of the over cap sidewall separate from the alignment snap bead, each securing snap bead having a length L² greater than the distance D of the break.

2. The cap guard as set forth in claim 1, further comprising:
a collar positioning indicator on an external surface of the collar sidewall, wherein the collar positioning indicator is aligned with the break; and
an over cap positioning indicator on an external surface of the over cap sidewall, wherein the over cap positioning indicator is aligned with the alignment snap bead.

3. The cap guard as set forth in claim 1, further comprising at least first and second securing snap beads.

4. The cap guard as set forth in claim 1, wherein an inner diameter and an outer diameter of the collar sidewall are larger than an inner diameter and an outer diameter, respectively, of the connecting rim.

5. The cap guard as set forth in claim 1, wherein an outer diameter of the collar sidewall is approximately equal to an outer diameter of the over cap.

6. In a bottle having a pump mechanism, a cap guard comprising:
an annular collar having a collar sidewall, a connecting rim extending from an upper portion of the collar sidewall, and an open top;
the collar sidewall having a collar internal snap bead extending at least partially around an interior of the collar sidewall adjacent a lower edge of the collar sidewall and the connecting rim having an external snap bead extending partially around an exterior surface of the connecting rim, the connecting rim external snap bead having at least one break therein and the break having a distance D;
an annular over cap having an over cap sidewall and a closed top surface;
an alignment snap bead extending around an internal surface of the over cap sidewall, the alignment snap bead having a length L¹ equal to or less than the distance D of the break;
one or more securing snap beads extending around a second portion of the internal surface of the over cap sidewall separate from the alignment snap bead, each securing snap bead having a length L² greater than the distance D of the break.

7. In the bottle as set forth in claim 6, the cap guard further comprising:
a collar positioning indicator on an external surface of the collar sidewall, wherein the collar positioning indicator is aligned with the break; and
an over cap positioning indicator on an external surface of the over cap sidewall, wherein the over cap positioning indicator is aligned with the alignment snap bead.

8. In the bottle as set forth in claim 6, the cap guard further comprising at least first and second securing snap beads.

9. In the bottle as set forth in claim 6, the collar sidewall having an inner diameter and an outer diameter that are larger than an inner diameter and an outer diameter, respectively, of the connecting rim.

10. In the bottle as set forth in claim 6, the collar sidewall having an outer diameter of the collar sidewall is approximately equal to an outer diameter of the over cap.

11. A method of assembling a bottle having a pump mechanism and a cap guard wherein removal of the cap guard for actuation of the pump mechanism requires coordinated action of both hands of a user to access the pump mechanism, comprising the steps of:
providing the cap guard with:
an annular collar comprising:
a collar sidewall;
a connecting rim extending from an upper portion of the collar sidewall;
an open top;
wherein the collar sidewall further comprises a collar internal snap bead extending around a portion of an interior of the collar sidewall adjacent a lower edge of the collar sidewall; and
wherein the connecting rim further comprises a connecting rim external snap bead extending partially around an exterior surface of the connecting rim, the connecting rim external snap bead comprising at least one break therein and the break having a distance D; and
an annular over cap comprising:
an over cap sidewall and a closed top surface;
an alignment snap bead extending around a first portion of an internal surface of the over cap sidewall, the alignment snap bead having a length L¹ equal to or less than the distance D of the break; and
one or more securing snap beads extending around a second portion of the internal surface of the over cap sidewall separate from the alignment snap bead, each securing snap bead having a length L² greater than the distance D of the break;
providing a neck of the bottle with a neck external snap bead;
sliding the annular collar over the pump mechanism and neck of the bottle such that the pump mechanism extends through the open top of the annular collar and to engage the collar internal snap bead with the neck external snap bead and exerting a force on the annular collar to force the collar internal snap bead past the neck external snap bead to secure the annular collar to the neck of the bottle in a freely rotatable manner; and
sliding the over cap over the connecting rim of the annular collar while aligning the alignment snap bead with the break to engage the one or more securing snap beads with the connecting rim external snap bead and exerting a force on the over cap to force the one or more securing snap beads past the connecting rim external snap bead to secure the over cap to the annular collar in a freely rotatable manner.

12. The method of assembling a bottle as set forth in claim 11, wherein the step of sliding the annular collar over the pump mechanism and neck of the bottle is performed before the step of sliding the over cap over the connecting rim of the annular collar.

13. The method of assembling a bottle as set forth in claim 11, wherein the step of sliding the annular collar over the pump mechanism and neck of the bottle is performed after the step of sliding the over cap over the connecting rim of the annular collar.
